(19) United States
(12) Patent Application Publication
(10) Pub. No.: US 2014/0112321 A1
(43) Pub. Date: Apr. 24, 2014

(54) ATTENDANT COMMUNICATION SYSTEM AND METHOD

(71) Applicant: RF TECHNOLOGIES, INC., Brookfield, WI (US)

(72) Inventors: Paul Larson, Menomonee Falls, WI (US); Bryan Tracey, Wauwatosa, WI (US)

(73) Assignee: RF Technologies, Inc., Brookfield, WI (US)

(21) Appl. No.: 13/655,325

(22) Filed: Oct. 18, 2012

(51) Int. Cl. H04W 40/00

(52) U.S. Cl. 370/338

(57) ABSTRACT

An attendant communications system may include one or more fixed location call stations and a mobile call station. The attendant communications system may further include one or more receive stations and a network configured to connect the fixed location call stations, mobile call station, and receive stations. The mobile call station may receive a user input and connect to a fixed location call station. A communications feature may then be provided to a receive station and the fixed location call station connected to the mobile call station.

### BACKGROUND

The present disclosure generally relates to the field of communication systems. The present disclosure relates more specifically to an attendant (e.g., nurse) call communication system.

Some nurse call systems used in hospitals (or other assisted living environments) may consist of call stations located near or with a patient. The call stations generally include a button which is activated (e.g., by a patient) to notify a nurse station. The nurse call station may then open a voice intercom (analog or voice over Internet Protocol or VoIP) channel to the patient, allowing the nurse using the nurse call station to determine the patient's needs prior to responding. The call station and nurse station can include a microphone and speaker to effect voice communication over the channel.

Due to cost considerations, intercom-capable systems may not be installed in some environments (e.g., senior living environments). Instead, a nurse located at a central nurse call station may receive a call that includes a room identifier. The nurse may receive the call via a console-based annunciator, a mobile device such as a pager, or another device. The nurse may then respond to the room that is the source of the call, and may determine the resident's request face-to-face. Such lower cost systems do not allow for voice communication prior to responding to the call.

There is a need for an attendant call system utilizing a low cost network (e.g., a mesh network) which does not require the specialized hardware of a conventional hospital nurse call system. Further, there is a need for an attendant call system for an attendant call system with a graphical user interface. Further, there is a need for fixed call stations that are Wi-Fi enabled and can provide voice communications. Further, there is also a need for a tablet-based attendant call system. Further, there is a need for a low cost, easy to install attendant call system that allows voice communication prior to responding to a call.

### SUMMARY

One embodiment relates to an attendant communications system. The system includes one or more fixed location call stations and a mobile call station. The mobile call station may connect to a fixed location call station via a wireless connection. The system further includes one or more receive stations and a network configured to connect the fixed location call stations, mobile call station, and receive stations. A communications feature may be provided to a receive station and the fixed location call station connected to the mobile call station via the network. The communications feature may include an audio and/or VoIP connection. The network may be a mesh network.

Another embodiment relates to a method for communications in an attendant communication system. The method includes receiving, at a mobile call station of the attendant communication system, a user input. The method further includes connecting the mobile call station to a fixed location call station of the attendant communication system, wherein the fixed location call station is part of a network of the attendant communication system. The method further includes providing a communications between the fixed location call station and a receive station of the attendant communication system. The method may further include providing the user input to the receive station of the attendant communication system. The communications feature may include an audio and/or VoIP connection. The network may be a mesh network.

Another embodiment relates to a computer readable storage medium having instructions stored therein, the instructions being executable by one or more processors to cause the one or more processors to perform operations. The instructions include receiving, at a mobile call station, a user input. The instructions further include connecting the mobile call station to a fixed location call station, wherein the fixed location call station is part of a network. The instructions further include providing a communications feature to the fixed location call station and a receive station part of the network. The communications feature may include an audio and/or VoIP connection. The network may be a mesh network.

Another embodiment relates to an attendant communications system and/or method including at least one fixed location call station, a mobile station and a receive station. The mobile call station is configured to receive a user input, wherein, upon receiving the user input, the mobile call station connects to a fixed location call station via a wireless connection. The fixed location call station and the receive station communicate via a wireless network, wherein voice communications between the receive station and the mobile call station is achieved through the wireless connection and the wireless network.

Another exemplary embodiment relates to a method of communicating in an attendant communication system. The method includes receiving, at a mobile call station of the attendant communication system, a user input, and connecting the mobile call station to a fixed location call station of the attendant communication system, wherein the fixed location call station is part of a network of the attendant communication system. The method also includes providing a human-based communication between the fixed location call station and a receive station of the attendant communication system in response to the user input.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view schematic drawing of an environment including a building area having multiple fixed location devices and mobile devices, according to an exemplary embodiment;

FIG. 2 is a perspective view schematic drawing of an environment including a building area illustrating an attendant communication system including multiple fixed location devices and mobile devices, according to an exemplary embodiment;

FIG. 3 is a general schematic block diagram of an example mesh network of the attendant communication system of FIG. 2, according to an exemplary embodiment;

FIG. 4 is a general schematic block diagram of a fixed call station of the attendant communication system, according to an exemplary embodiment;

FIG. 5 is a general schematic block diagram of a mobile call station of the attendant communication system, according to an exemplary embodiment;

FIG. 6 is a general schematic block diagram of a fixed location receive station of the attendant communication system, according to an exemplary embodiment;

FIG. 7 is a general schematic block diagram of a mobile receive station of the attendant communication system, according to an exemplary embodiment;

FIG. 8 is a schematic drawing of a user interface of a call station, according to an exemplary embodiment;

FIG. 9 is a schematic drawing of a user interface of a call station, according to another exemplary embodiment; and

FIG. 10 is a flow chart of a process of the attendant communication system, according to an exemplary embodiment.

### DETAILED DESCRIPTION OF THE EXEMPLARY EMBODIMENTS

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting.

Referring generally to the figures, an attendant (e.g., a nursing) communication system is shown and described. The nursing communication system may include multiple devices configured to send and receive information between patients or residents and nurses or other attendants. The nursing communication system may be a system capable of providing audio and video communication capabilities to the occupants (e.g., patients, residents, nurses, doctors, etc.) of a building or building area (e.g., a hospital, a senior living environment, an assisted living environment, or any other building or environment where such communications are advantageous), in one embodiment. The nursing communication system may include multiple fixed location and/or mobile devices (e.g., a call station) configured to allow an occupant to provide a request or other input, and multiple fixed location and/or mobile devices (e.g., a receive station) configured to allow another occupant to provide a response, in one embodiment. The various devices of the nursing communication system may be wireless enabled and may communicate with one another in the nursing communication system via a mesh network, for example. In other embodiments, the various devices may have wired connections (e.g., Ethernet cabling), other types of wireless connections, or any combination of types of connections with each other.

In one embodiment, a patient or resident may use a mobile call station to provide a request or other input to the attendant communication system. The mobile call station may be, for example, a mobile pendant or other mobile electronic device that can be carried by the patient or resident. The act of receiving an input at the mobile call station may be used as an activation of the attendant communication system. After receiving the occupant input, the mobile call station may join the network of the attendant communication system at the nearest access point (e.g., by wirelessly connecting to a fixed location call station or receive station), in one embodiment. The fixed location stations may be used as reference points to allow the attendant communication system to determine the location of the mobile call station (and the patient or resident by extension), in one embodiment. The attendant communication system may then open an audio and/or video connection to the nearest capable device (e.g., the call station with the original connection to the mobile call station, or another station) between the patient or resident and a nurse or other attendant, in one embodiment.

While the present disclosure describes the attendant communication system as a nursing communication system, it should be understood that the communication system described herein may be implemented in other environments without departing from the scope of the present disclosure. The environment in which the nursing communication system is described in the present disclosure is provided as an example environment in which such a system may be implemented.

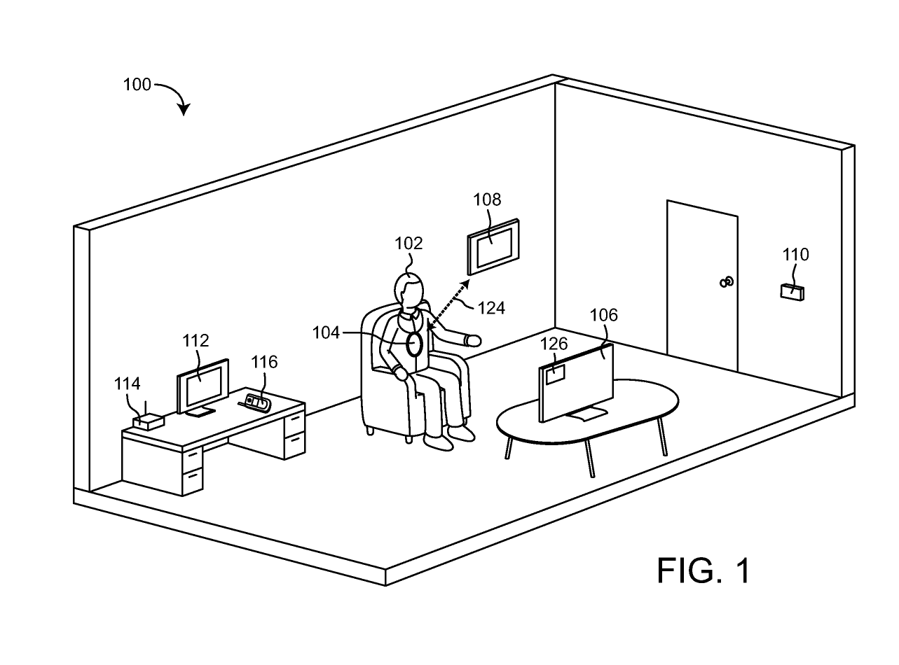

Referring to FIG. 1, an environment view of a building area 100 including multiple fixed location devices 106, 108, 110, 112, and mobile devices 104, 116 is shown, according to an exemplary embodiment. The term fixed as used herein does not necessarily mean unmovable. Fixed devices 106, 108, 110, 112 are fixed in that the devices are provided in a known location (such as at a charging station from which the devices can be detached for mobile operation or at a bracket or other fixture for holding the device) or are generally not moved in their normal operation. Building area 100 is shown as a living or residential area for an occupant 102 and devices 104-116. Multiple devices 102-116 are shown as examples of devices that may be included in an attendant communication system. It should be understood that the example building area 100 shown in FIG. 1 is provided as an example only and that the configuration of the environment, and multiple devices 104-116 may vary according to different embodiments.

Devices 104-116 may be devices that are part of a nursing communication system. For example, device 104 may be a mobile device such as a mobile pendant. Device 116 may be a smart phone or other mobile device that can be carried by occupant 102. The mobile pendant and smart phone may generally be devices including one or more user interface features and wireless capabilities to communicate with nearby devices. Occupant 102 may use mobile pendant or device 104 or 116 to, for example, signal for help, send a message to a nurse, etc. Mobile pendant or device 104 or 116 may be a wireless capable device able to communicate wirelessly with other wireless enabled devices. Upon receiving a user input, mobile pendant or device 104 or 116 may connect to another device that is part of the nursing communication system. For example, mobile pendant or device 104 or 116 may establish a wireless link 124 to device 108 (shown as a wall-mounted tablet computer). Wireless link 124 can be provided according to a variety of protocols. Wireless link can be a Bluetooth® or ZigBee communication link between a smart phone and tablet computer or laptop computer in one embodiment. Wireless link 124 can also be a proprietary link associated with RF tag systems between pendant 116 and device 108. The user input may be sent to a receive station located remotely from building area 100 to alert a nurse or other attendant. A communication representing the user input may be sent from mobile pendant or device 104 or 116 or any device capable of communication with mobile pendant or device 104 or 116. The communication may include data representing a type of request from the user, the time of the request, the user identification, the identification of the device 104 and 116, the location of the device 104 or 116, the motion status of the device 104 or 116, the battery power for device 104 and 116, the charging status of device 104 and 116, etc. Upon receipt of communication associated with the user input at receive station 108, a communications link (e.g., an audio and/or video communications link) may be opened at the receive station and at, for example device 108 (or another device configured to establish the communications link that occupant 102 can access). Occupant 102 may then communicate with the nurse via device 108.

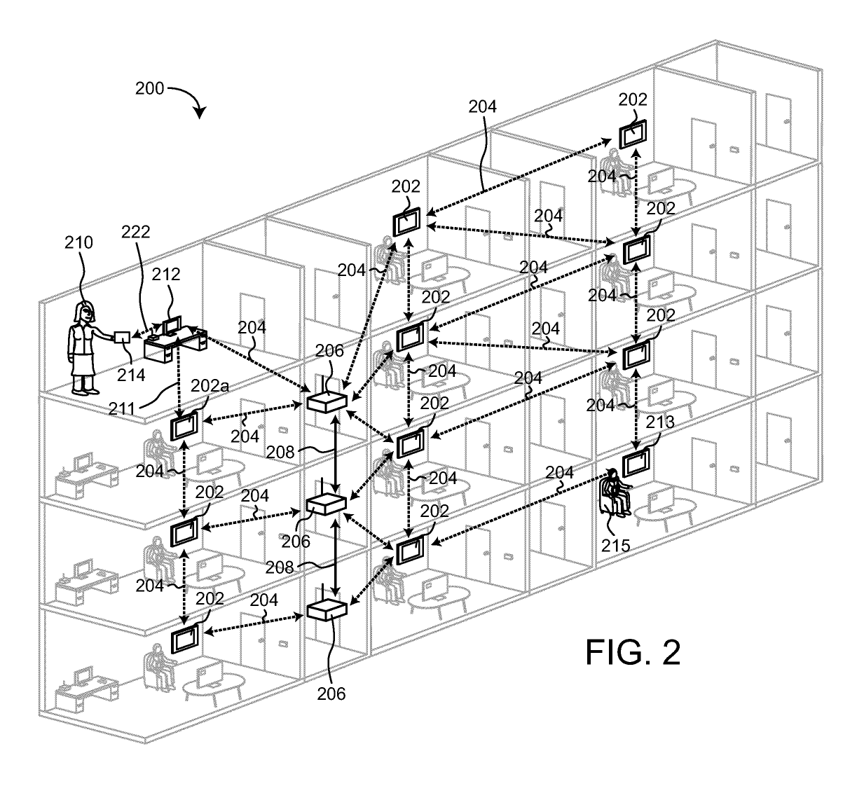

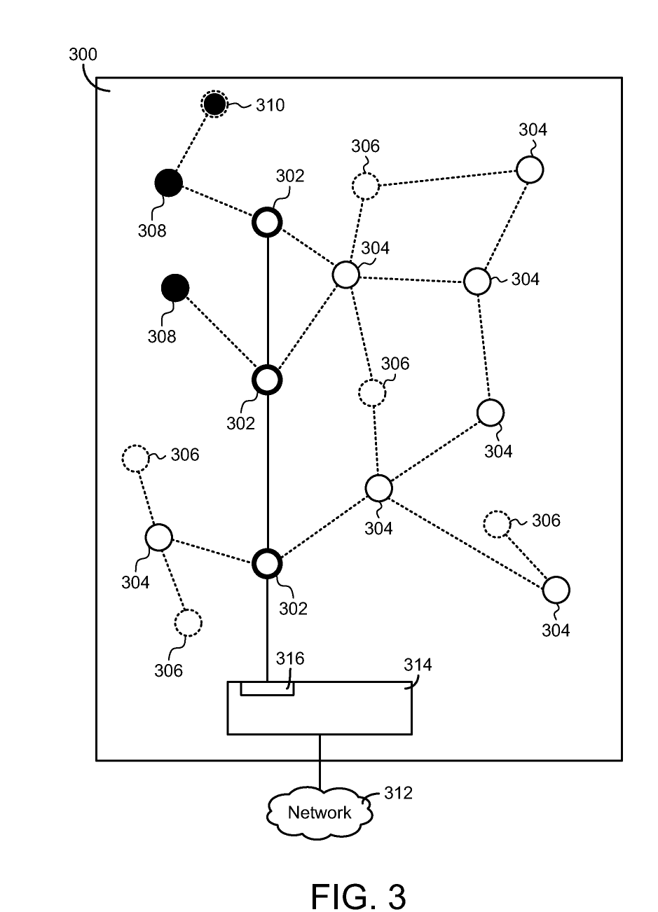

Building area 100 is shown to include various examples of devices 106, 108, 110, 112, 114 to which mobile pendant or device 104 or 116 may wirelessly connect. For example, area 100 may include a smart television or device 106, a wall-mounted device 108 or 110 as described above, a desktop 112, a router 114, a laptop, a tablet, a smart phone, or any other type of device configured to wirelessly connect to other devices of the attendant communication system. In one embodiment, device 108 may be a computer tablet, such as an iPad computer by APPLE or other tablet computer. Devices 104-116 may be capable of communicating with one another and with other devices via a mesh network or another network as described in FIGS. 2-3. Further devices 104-116 may have a wired connection with other devices in building area 100 or remotely with other devices. Devices 104-116 may generally be configured to either provide a user interface to occupant 102 for interaction with a remotely located user (e.g., nurse), or to connect to another device that is capable of such interaction.

The various devices 108, 110, 112, 114 may include various features that allow occupant 102 to interact remotely with another user via the communications link. For example, if occupant 102 interacts with smart television 106, occupant 102 may use a remote control to interact with an attendant. As another example, if smart television 106 includes a motion sensor 126, occupant 102 may gesture (e.g., moving his or her hand in a particular motion) in order to provide a response. As yet another example, one or more devices 108, 110, 112, 114 may include a microphone configured to receive occupant 102 speech and to transmit the audio to the attendant. As yet another example, device 106 or 108 may include a touch screen, and occupant 102 may select an option or enter a message using the touch screen. It should be understood that the type of interaction between occupant 102 and devices 104-116 may include various input actions.

Referring now to FIG. 2, multiple building areas are shown in an environment 200. FIG. 2 illustrates a network of the attendant communication system capable of providing a user input from a mobile call station (e.g., mobile pendant 104) to a receive station. Each building area in environment 200 is shown to include a call station 202 such as a wall-mounted tablet device. In FIG. 2, other devices and building areas are shown grayed out for illustrative and simplistic purposes only. It should be understood that any of the devices in each building area may be capable of communications in environment 200 as described with respect to call stations 202.

Each call station 202 may be capable of wireless communications, and may wirelessly communicate with (e.g., be in range of) one or more other call stations 202 via a wireless connection 204. For example, some call stations 202 are shown to have a wireless connection 204 with one, two, or more call stations 202. Further, some call stations 202 may have a wireless connection 204 with one or more access points 206.

Environment 200 is shown to include multiple access points 206 that may connect to some of call stations 202. Multiple access points 206 may be located anywhere in environment 200 such that any call station 202 may communicate with any other call station 202 via other call stations and access points 206. Multiple access points 206 may be connected to one another via a wired connection 208. For example, multiple access points 206 may form a backbone of Wi-Fi access points and call station 202 can communicate according to Wi-Fi protocol.

Call station 202a is shown connected to a fixed location receive station 212 via a wireless link 211. Receive station 212 may receive any user input from any call station 202 via other call stations 202 and links 204. Receive station 212 may receive various inputs from various occupants of environment 200 and may be configured to manage the user inputs for an attendant 210. For example, receive station 212 may triage the user inputs to determine which messages are most important. Triage priority may be determined by the type of call. For example, a button or voice indicating a fall would have a higher priority than a button or voice indicating a need for food. Further, triage priority may involve the identity of the user. Receive station 212 may further be configured to provide an audio and/or video communications link with any other device in environment 202 if necessary. Receive station 212 may be, for example, a desktop, laptop, tablet, or other device configured to manage interactions in environment 200. In one embodiment, receive station 212 stores the voice or video provided by call stations 202 so that they can be reviewed by attendant 210. For example, if two or more calls are simultaneously made, attendant can respond to the highest priority call with a live link and review the lower priority call (including the audio or video message) stored in station 212 when available.

In one building area of environment 200, an attendant 210 (e.g., a nurse) is shown with a mobile receive station 214. Mobile receive station 214 is shown to have a wireless link 222 with receive station 212. In various embodiments, mobile receive station 214 may receive a user input from receive station, from a call station 202, or via any other device in the network in environment 200.

Mobile receive station 214 may be a smart phone, tablet, or other mobile device that can be carried by attendant 210. Mobile receive station 214 may be configured to provide an audio and/or video connection to another device of environment 200. For example, attendant 210 may choose to open an audio and/or video link to any call station 202 upon receiving a message from the call station 202. Mobile receive station 214 may allow attendant 210 to communicate via the other call stations 202 without returning to a nurse station or other base station (for example, to receive station 212, any other fixed location device, etc.).

As an example of an interaction in environment 200, an occupant 215 provides a user input to call station 213 (either directly to call station 213 or via a mobile call station wirelessly connected to call station 213). The user input may traverse or be communicated via the network in environment 200 until it reaches a receive station 212 or 214. Receive station 212 may receive the user input and determine if and when to provide the input to receive station 214 and attendant 210, or the user input may go directly to receive station 214 and attendant 210. Upon receiving the user input, attendant 210 may open an audio and/or video connection with call station 213 using receive station 214 (or another device). This may allow attendant 210 to communicate with occupant 215. In one embodiment, the audio and/or video channel is automatically opened when attendant 210 responds to the user input. The communication associated with the user input can use the identity of station 213 to locate occupant 215.1

While receive stations 212 and 214 are shown in the same building area, it should be understood that receive stations 212, 214 may be configured such that attendant 210 may be anywhere in environment 200 and still be able to receive information from receive station 212, or from any other device in environment 200.

In one embodiment, as shown in FIG. 2, the various devices shown may be networked together via a mesh network. In another embodiment, the various devices may be networked together via a combination of wireless and wired connections (e.g., Ethernet cabling) in any type of network topology. In the embodiment of FIG. 2, the various call stations 202 are shown forming a mesh network such that all call stations 202 may communicate with at least one access point 206.

Referring now to FIG. 3, a block diagram of an example wireless mesh network 300 of the attendant communication system is shown. A mesh network is a network that is spread out among many devices (e.g., nodes) that communicate with one another to share the network connection across a large area (e.g., environment 200). Each device or node of mesh network 300 may act as transmitters that act as a wireless router.

Mesh network 300 includes multiple fixed location call stations 304 (illustrated in solid lines) and multiple mobile call stations 306 (illustrated in dotted lines). Each mobile call station 306 may connect wirelessly with one or more fixed location call stations 304 (shown via the dotted lines in FIG. 3), and the fixed location call stations 304 may be connected to one another and access points 302 such that each fixed location call station 304 is connected all other devices in mesh network 300. Multiple access points 302 may be connected to one another wirelessly or via a wired connection (shown via the solid lines in FIG. 3). In one embodiment, mobile call stations 306 provide access to the network and to the Internet via network 300.

For each mobile call station 306, a particular wireless connection with a fixed location call station 304 may be disabled or otherwise unavailable. The mobile call station 306 may be configured to automatically connect or reconnect to the nearest suitable call station 304 within range of call station 306. Mesh network 300 allows any device or node to connect to the network. For example, any mobile call station 306 may connect to a fixed location call station 304 at any time and be incorporated into the network. The identity of the nearest suitable call station 304 can be used to locate occupant 215 who initiated the user input.

Each call station 304 or 306 may be configured to determine a shortest path or otherwise exemplary path in which to send data to receive station 308, 310 (or another destination). For example, before transmitting a user input, a mobile call station 306 may calculate or determine a shortest path in mesh network 300 to receive station 310, and connect to the appropriate fixed location call station 304.

Multiple fixed location receive stations 308 may also connect to any of the devices in mesh network 300. A mobile receive station 310 may connect to a fixed location receive station 308 in the same manner as call stations 304, 306. Therefore, for a user input at a mobile call station 304, a mobile receive station 310 may receive the user input via mesh network 300.

In mesh network 300, one of the access nodes 302 is shown connected to network 312 (e.g., the Internet) via a controller system 314 and interface 316 of the controller system. In mesh network 300, only one of the nodes (access node 302, node 304, 308, etc.) need to be connected to network 312 (e.g., Internet) via a wired connection in order to provide the connection to the rest of the mesh network. Controller system 314 may be configured to manage the connection with network 312 and any other aspect of mesh network 300 operation.

In various other embodiments, the devices (e.g., nodes) may be linked in any way. For example, standard Ethernet cabling may be used to link some or all devices 302-310. As another example, a backbone of wireless access points 302 may be included as generally shown in FIG. 3. It should be understood that any combination of networks (e.g., a mesh network connected to access points 302) may be used with the systems and methods of the present disclosure. Network 312 may also be access via a wireless connection, in one embodiment.

In one embodiment, mobile devices 304, 310 may be tablets. The tablets may be wirelessly tethered to an internal local area network (LAN) via a wireless network, or multiple tablets may form their own local mesh network. The wireless network and wireless connections may use WiFi technology or may use other wireless technology such as ZigBee.

In one embodiment, mobile devices 304 may be mobile pendants. The pendants may be wirelessly tethered to an internal LAN via a wireless network or by using the other devices (e.g., one or more nodes 304 such as tablets) as a connectivity bridge. The bridge may be used to connect two or more different network segments (e.g., different LANs) that are separated (physically separated, or logically separated by protocol). A node 304 such as a tablet may be used as a bridge between devices in two different building areas. The bridge may use WiFi, Bluetooth, ZigBee, or any other type of point-to-point wireless protocol.

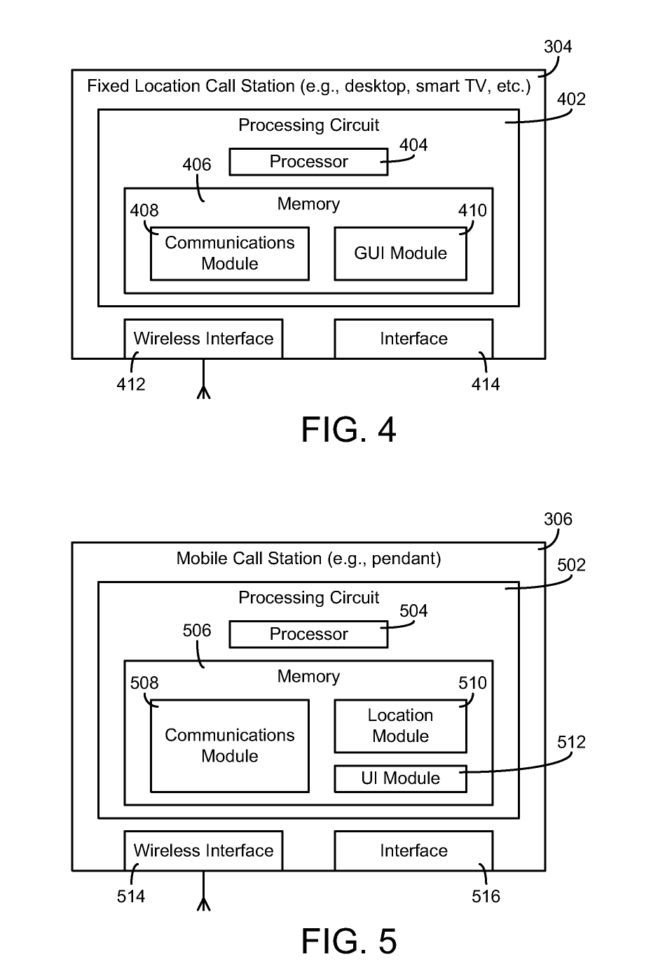

Referring generally to FIGS. 4-7, various block diagrams of call stations and receive stations are described in greater detail. The call stations and receive stations may include various modules configured to facilitate communications between each other as described with reference to FIGS. 1-3. While some functionality is described with respect to one or more particular devices in FIGS. 4-7, it should be understood that the functionality described may be executed in any of the devices of FIGS. 4-7 without departing from the scope of the present disclosure. For example, while the devices in FIGS. 4-7 include wired and wireless interfaces, it should be understood that each device may include one or both of a wired and wireless interface.

Referring to FIG. 4, a block diagram of a fixed location call station 304 is shown in greater detail, according to an exemplary embodiment. A fixed location call station may be, for example, a wall-mounted device such as a tablet, smart television, or other device. Fixed location call station 304 may be located in a building area (e.g., a resident room) in convenient locations such than an occupant can easily access and use fixed location call station 304. Fixed location call station 304 may generally be configured to establish a connection with a mobile call station 306 and to provide a user interface (e.g., audio and/or video connection) for a user of mobile call station 306 for communications with another person. In one embodiment, call station 304 can be fixed to a cradle for charging and may be removable for the cradle to be useable as a mobile device as well. In such an embodiment, call station 304 can provide an indication of whether it is charging or whether it is attached to the cradle in its communication with device 212, Such information can be used to located occupant 215. In one embodiment, if station 304 is mobile or out of its cradle, station 304 can provided location data in the communication to device 212. the location data can be derived from access points to network 300 or from GPS data.

Fixed location call station 304 includes processing electronics 402 including a processor 404 and memory 406. Processor 404 may be implemented as a general purpose processor, an application specific integrated circuit (ASIC), one or more field programmable gate arrays (FPGAs), a group of processing components, or other suitable electronic processing components. Memory 406 is one or more devices (e.g., RAM, ROM, Flash memory, hard disk storage, etc.) for storing data and/or computer code for completing and/or facilitating the various processes described herein. Memory 406 may be or include non-transient volatile memory or non-volatile memory. Memory 406 may include data base components, object code components, script components, or any other type of information structure for supporting the various activities and information structures described herein. Memory 406 may be communicably connected to processor 404 and includes computer code or instructions for executing one or more processes described herein.

Memory 406 is shown to include a communications module 408. Communications module 408 may be configured to manage communications with other devices of the attendant communication system. For example, a mobile call station 306 may communicate wirelessly with call station 304 via wireless interface 412, and communications module 408 may manage the connection. Communications module 408 may include logic for determining a location of a mobile call station 306 relative to call station 304, and to use the location information and other information to determine whether mobile call station 306 should connect to call station 304. For example, when mobile call station 306 receives a user input, mobile call station 306 may communicate with multiple call stations 304, and the communications modules 408 of call stations 304 may determine to which call station 304 the mobile call station 306 should connect (e.g., by identifying the call station 304 physically nearest to mobile call station 306, by identifying the call station 304 to which the shortest path in the mesh network to a receive station is available, etc.).

As another example, a receive station 308 or 310 may communicate wirelessly with call station 304 via wireless interface 412, and communications module 408 may manage the connection (e.g., by transmitting an audio, video, or textual input at call station 304 to the receive station, receiving such an input from the receive station, etc.). Wireless interface 412 may be configured to communicate with other devices via a LAN, wide area network (WAN), or other network via Wi-Fi, ZigBee, Bluetooth, or any other type of wireless technology.

Memory 406 is shown to include a graphical user interface (GUI) module 410. GUI module 410 is configured to provide an interface to a user of fixed location call station 308. For example, if an audio and/or video communications link is opened between call station 304 and a receive station, GUI module 410 may be configured to provide a user interface allowing a user to provide an audio input, to provide an input by touching a touch screen of call station 304, to provide an input via remote control or other remote device wirelessly connected to call station 304, or otherwise. GUI module 410 may further be configured to interpret a user input received at interface 414 (e.g., to detect and interpret a gesture detected by a motion sensor, to interpret an audible input using voice to text methods, to interpret a user touch at the touch screen, etc.).

In one embodiment, GUI module 410, and more generally call station 304, may be configured to detect a user input not received by the user interface. Instead of interacting with a user interface of call station 304, the user may want to communicate with call station 304 by talking to the device. For example, in an emergency situation, a user may not be able to access call station 304 other than by voice. Call station 304 and GUI module 410 may be configured to detect and receive an audio input from the user without prior user interaction with call station 304, and to interpret the audio input to determine a request or message to provide to a receive station.

Referring to FIG. 5, a block diagram of a mobile call station 306 is shown in greater detail, according to an exemplary embodiment. A mobile call station may be, for example, a mobile pendant or other mobile device. Mobile call station 306 may be a device carried by an occupant (e.g., a resident or patient) and activated by the occupant upon pressing a button or otherwise interacting with the user interface of mobile call station 306. Mobile call station 306 may be used by the occupant to provide a request or other message to an attendant (e.g., nurse) via a fixed location call station and receive station. Mobile call station 306 includes a processing circuit 502 including a processor 504 and memory 506, which may be of similar functionality to processing circuit 402, processor 404, and memory 406 as described above.

Memory 506 is shown to include a communications module 508 configured to establish a communications link with a fixed location call station 304 (or other device) via wireless interface 514. In one embodiment, communications module 508 may detect multiple call stations 304 and determine to which call station 304 the mobile call station 306 should connect. For example, communications module 508 may determine which call station 304 is physically closest or most accessible to the user of mobile call station 306. Wireless interface 514 may be configured to communicate with other devices via a LAN, wide area network (WAN), or other network via Wi-Fi, ZigBee, Bluetooth, or any other type of wireless technology. Determination of closeness can use RSSI levels associated with signals from access points or stations 202.

Memory 506 is shown to include a location module 510. Location module 510 is configured to determine a location of mobile call station 306 in a building area or environment, or relative to other devices in the attendant communication system. While location module 510 is shown in mobile call station 306, location module 510 may be located in other devices of the attendant communication system and may determine the location of mobile call station 306 remotely.

The location of mobile call station 306 may be determined in various ways. In one embodiment, location module 510 (or communications module 508) may use signal strength between mobile call station 306 and one or more fixed location call stations or receive stations (devices whose positions are already known in the attendant communication system) to determine the location of mobile call station 306. Determination of closeness can use RSSI levels associated with signals from access points or stations 202 in one embodiment. In another embodiment, a time of flight (e.g., the transmittal time of a message to and from mobile call station 306 to other devices in the nursing communication system) may be used to calculate the location of mobile call station 306. In yet another embodiment, presence information (e.g., a status indicator that indicates an ability of mobile call station 306 to connect with another device in the attendant communication system) may be used to determine the location of mobile call station 306. The measurements made by location module 510 may occur via various types of wireless technology (e.g., Wi-Fi, Bluetooth, ZigBee) or via various types of presence detection techniques (e.g., via infrared or ultrasound).

In one embodiment, location module 510 may determine the location of mobile call station 306 using known location information about a charging station. For example, a fixed location call station 308 such as a tablet may be located at a charging station for the device. The location of the charging station may be known (e.g., in a fixed location), and the location of the charging station may be used in addition to or instead of other location information related to wireless communications between stations 306, 308. As another example, if mobile call station 306 is connected to a charging station itself, the location of call station 306 may be determined if the location of the charging station is already known by mobile call station 306 or another device wirelessly connected to call station 308 or the charging station.

Memory 506 is shown to include a UI module 512. UI module 512 is configured to manage user interaction with mobile call station 306. For example, if call station 306 is a mobile pendant, UI module 512 may be configured to receive a user input at interface 516 and to interpret the user input (e.g., a request for help or other message). In one embodiment, UI module may be configured to detect a voice of the user as the user input. For example, in an emergency situation, a user may only be able to provide an input by voice. Call station 306 and UI module 512 may be configured to detect and receive the audio input from the user, and to interpret the audio input to determine a request or message to provide to a receive station.

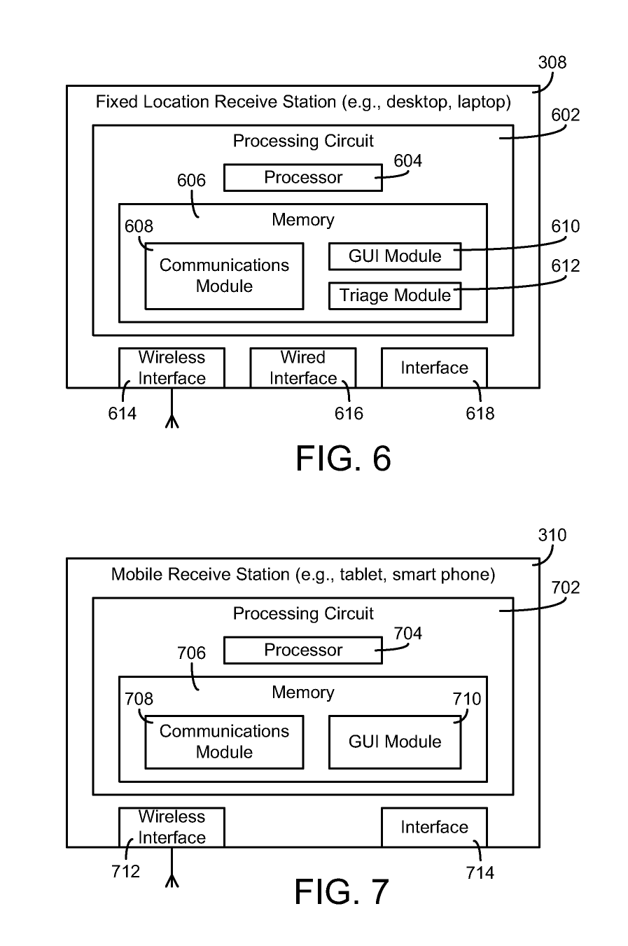

Referring to FIG. 6, a block diagram of a fixed location receive station 308 is shown in greater detail, according to an exemplary embodiment. A fixed location receive station may be, for example, a tablet personal computer (PC), desktop PC, laptop PC, or other such device. Fixed location receive station 308 may be a device accessible by an attendant (e.g., a nurse) responsible for receiving and responding to requests from other occupants of the building area, or may be a device configured to establish a communications link between multiple mobile devices of the attendant communication system. Fixed location receive station 308 may act as a station (e.g., a nurse station) that serves as a base for the attendant or may be any device simply part of the attendant communication system. Fixed location receive station 308 includes a processing circuit 602 including a processor 604 and memory 606, which may be of similar functionality to processing circuit 402, processor 404, and memory 406 as described above.

Memory 606 is shown to include a communication module 608. Communications module 608 may be configured to manage communications with other devices of the nursing communication system. For example, receive station 308 may communicate wirelessly with a fixed location call station 304 (or other device) or mobile receive station 310 via wireless interface 614 or wired interface 616, and communications module 608 may manage the connection. The wireless communications may include VoIP capability, an audio connection, or any other type of connection that allows a user of receive station 308 to communicate with a user of call station 304 (e.g., to relay information back and forth between occupants) or receive station 310 (e.g., alerting an attendant that another occupant needs assistance). Wireless interface 614 may be configured to communicate with other devices via a LAN, wide area network (WAN), or other network via Wi-Fi, ZigBee, Bluetooth, or any other type of wireless technology. Wired interface 616 may be configured to communicate with other devices via an Ethernet connection or any other type of wired connection.

Memory 606 is shown to include a GUI module 610. GUI module 610 may be configured to provide an interface to a user of receive station 308. For example, an audio and/or video communications link may be opened between a call station 304 and receive station 308, and GUI module 410 may be configured to provide a user interface allowing a user to provide an audio input, to provide an input by touching a touch screen of receive station 308, to provide an input via remote control or other remote device wirelessly connected to receive station 308, or otherwise. GUI module 410 may further interpret user inputs at the user interface via interface 618.

Memory 606 is shown to include a triage module 612. In one embodiment, receive station 308 may be configured to receive multiple user inputs (e.g., multiple user requests). Triage module 612 may be configured to receive the inputs and triage the calls (e.g., to determine the priority of treatment for users based on the severity of condition of the user). For example, a user input relating to an emergency may be prioritized, a user input relating to a general request may be de-prioritized, etc. Triage module 612 may be used to determine which requests or user inputs are viewed by a user of receive stations 608 or 610.

Referring to FIG. 7, a block diagram of a mobile receive station 310 is shown in greater detail, according to an exemplary embodiment. A mobile receive station may be, for example, a smart phone, tablet PC, or other mobile device. Mobile receive station 310 may be a device carried by a user (e.g., a nurse) and may receive an input from fixed location call station 304 or mobile call station 306 (or another device). The input may be an alert or message in response to a user input at a call station. Mobile receive station 310 may be used to respond to the user input without having to return to a nurse station or other base. Mobile receive station 310 includes a processing circuit 702 including a processor 704 and memory 706, which may be of similar functionality to processing circuit 402, processor 404, and memory 406 as described above.

Memory 706 is shown to include a communications module 708. Communications module 708 may be configured to manage communications with other devices of the attendant communication system. For example, receive station 310 may communicate wirelessly with a fixed location call station 304 (or other device) via wireless interface 712, and communications module 708 may manage the connection. The wireless communications may include VoIP capability, an audio connection, or any other type of connection that allows a user of receive station 310 to communicate with a user of call station 304.

Memory 706 is shown to include a GUI module 710. GUI module 710 may be configured to provide an interface to a user of receive station 310. For example, an audio and/or video communications link may be opened between a call station 304 and receive station 310. GUI module 410 may be configured to provide a user interface by allowing a user to provide a and GUI module 410 may be configured to provide a user interface allowing a user to provide an audio input, to provide an input by touching a touch screen of receive station 310, or otherwise. GUI module 410 may further interpret user inputs at the user interface via interface 714.

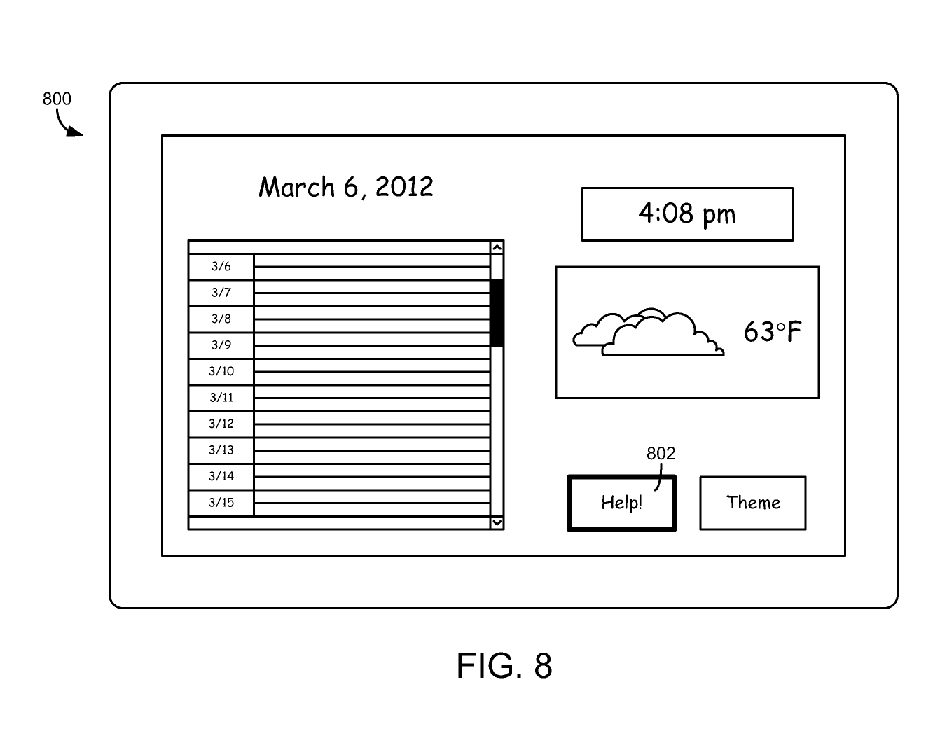

Referring now to FIG. 8, an exemplary user interface 800 of a call station (e.g., a fixed location call station such as a tablet or a mobile call station) is shown. User interface 800 is shown to include various functionality, including a clock, calendar, weather, and other features. User interface 800 is shown to include a “Help!” button 802 that a user may select. Upon selection of button 802, the call station may connect to the mesh network of the nurse communication system. A user interface may then be provided that allows the user to communicate with another user remotely. The user interface may be configured to display information from the other user, to display text from the other user, or to allow the user to further select or provide information to provide to the other user.

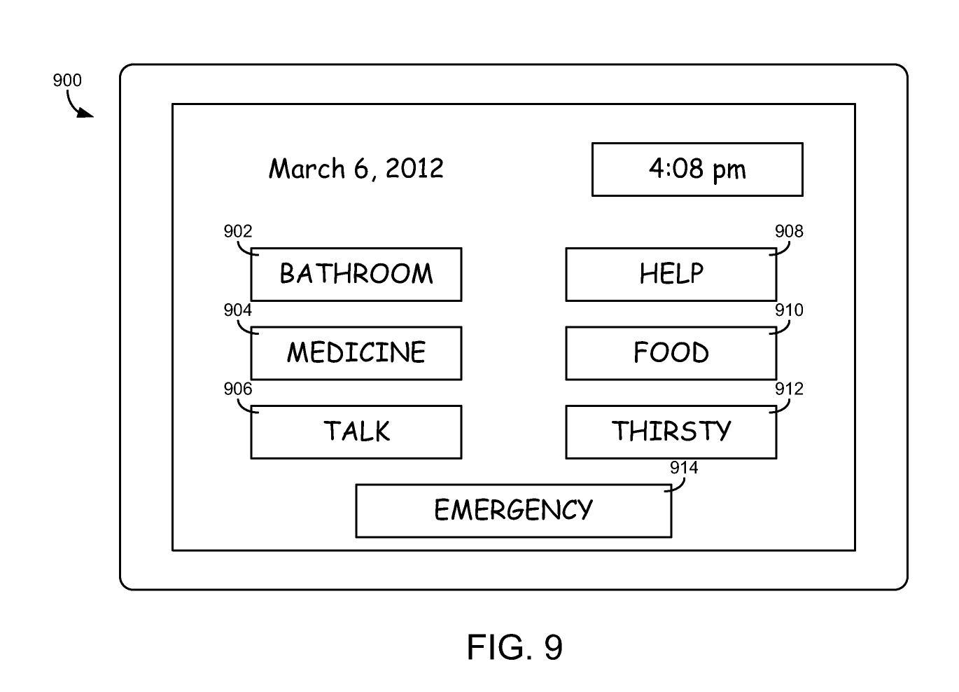

Referring now to FIG. 9, an exemplary user interface 900 of a call station is shown. User interface 900 may be presented to a user of a call station (e.g., a tablet) or may be provided to the user after selection of “Help!” button 802 (e.g., a user touching button 802 on interface 800) or another similar user input. User interface 900 is shown to include various buttons 902-914 that a user may select. For example, button 902 may indicate that the user needs assistance in going to the bathroom, button 904 may indicate that the user needs an attendant to provide medicine to the user, button 906 may indicate that the user would like to talk to a nurse or other attendant, button 908 may indicate a general request for help, button 910 may indicate a user request for food to the attendant, button 912 may indicate that the user is thirsty and needs water or other fluids, and button 914 may indicate an emergency situation. User interface 900 may include any other type of button or user input functionality to allow the user to provide a message for an attendant.

The menus shown in user interfaces 800, 900 provide options to a user via text. In various other embodiments, the menus provided to a user via user interfaces 800, 900 may include pictures, symbols, icons, or any other visual output. For example, icons related to each option may be displayed and selectable by a user.

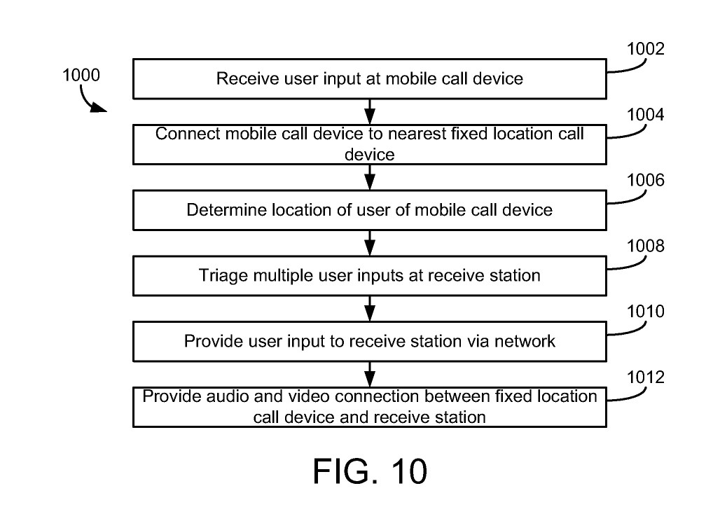

Referring now to FIG. 10, a process 1000 of the attendant communication system is shown, according to an exemplary embodiment. Process 1000 includes receiving a user input at a mobile call device (step 1002). The mobile call device may be, for example, a mobile pendant, or other mobile device. The user input may be a simple button press, or may be an audio or textual input from the user.

Process 1000 may further include the mobile call device connecting to the nearest fixed location call device (step 1004). In other words, step 1004 includes connecting the mobile call device to the mesh network of the attendant communication system. The mobile call device may connect to the mesh network as generally described in FIG. 3.

Process 1000 may further include determining the location of the user of the mobile call device (step 1006). Step 1006 may include determining the location of the mobile call device (and user) relative to the fixed location call devices to which the mobile call device may connect. Determining the location may include using various call device information. For example, signal strength between the mobile call device and fixed location call devices, a time of flight (e.g., time it takes to transmit a message to and receive a message from a fixed location call device), or simply presence information between the mobile device and nearby fixed location call devices may be used. Such measurements may occur via Wi-Fi, Bluetooth, ZigBee, or any other type of wireless technology, or by presence detectors such as infrared presence detectors or ultrasound presence detectors.

Process 1000 may optionally include the step of triaging multiple user inputs at a receive station (step 1008). For example, in a nursing communications system, there may be multiple occupants providing a user input at any given time. A receive station may receive the user inputs and triage the calls (e.g., determining the priority of each call based on the severity of the condition of the user). The receive station that triages the user inputs may be a mobile receive station carried by a nurse or a fixed location receive station that passes on the calls to the mobile receive station after triage.

Process 1000 further includes providing the user input to a receive station via the network of the attendant communication system (step 1010). The user input may include the location information of the user and mobile call device. The receive station may be a mobile receive station carried by an attendant, according to an exemplary embodiment.

Process 1000 further includes providing an audio and/or video connection between the fixed location call device and receive station (step 1012). The connection may allow the user of the mobile call device and the attendant using the mobile receive station to communicate with one another.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. An attendant communications system, comprising:
at least one fixed location call station;
a mobile call station; the mobile call station configured to receive a user input, wherein, upon receiving the user input, the mobile call station connects to a fixed location call station via a wireless connection; and
at least one receive station, wherein the fixed location call station and the receive station communicate via a wireless network, wherein voice communications between the receive station and the mobile call station is achieved through the wireless connection and the wireless network.

2. The system of claim 1, wherein video communication is provided between the receive station and fixed location call station.

3. The system of claim 1, wherein the fixed location call station, mobile call station, and receive station are wireless enabled.

4. The system of claim 3, wherein the wireless network is a mesh network comprising a number of other fixed location call stations.

5. The system of claim 1, wherein further comprising at least one mobile receive station;
wherein a mobile receive station receives the user input via the wireless network.

6. The system of claim 1, wherein the mobile call station is a mobile pendant;
wherein the mobile pendant includes an interface allowing a user to provide an input to the attendant communication system.

7. The system of claim 1, wherein the location call station is a tablet, desktop, laptop, television, or mobile phone.

8. The system of claim 1, wherein the mobile call station determines a location of the user of the mobile call station using the fixed location call station; and
wherein the location is provided to the receive station.

9. The system of claim 1, wherein the receive station is configured to receive more than one user input from the mobile call stations and to triage the user inputs.

10. A method of communicating in an attendant communication system, comprising:
receiving, at a mobile call station of the attendant communication system, a user input;
connecting the mobile call station to a fixed location call station of the attendant communication system, wherein the fixed location call station is part of a network of the attendant communication system; and
providing a human-based communication between the fixed location call station and a receive station of the attendant communication system in response to the user input.

11. The method of claim 10, further comprising providing the user input to the receive station of the attendant communication system.

12. The method of claim 11, further comprising receiving multiple user inputs at the receive station and triaging the user inputs.

13. The method of claim 11, further comprising:
determining the location of a user of the mobile call station using fixed location call station location information; and
providing the location information as part of the user input to the receive station.

14. The method of claim 10, wherein the human-based communication is provided as one or both of an audio connection and a video over internet protocol (VoIP) connection;
wherein the communication is provided over a channel of communication between the receive station and fixed location call station.

15. The method of claim 10, wherein the fixed location call stations, mobile call stations, and receive stations are wireless enabled; and
wherein the network is a mesh network comprising the fixed location call station, mobile call station, and receive station.

16. The method of claim 10, wherein the mobile call station is a mobile pendants;
wherein the mobile pendants include an interface allowing a user to provide an input to the attendant communication system.

17. A computer readable storage medium having instructions stored therein, the instructions being executable by one or more processors to cause the one or more processors to perform operations, comprising:
receiving, at a mobile call station, a user input;
connecting the mobile call station to a fixed location call station, wherein the fixed location call station is part of a network; and
providing a communications feature to the fixed location call station and a receive station part of the network.

18. The computer readable storage medium of claim 17, wherein the communications feature is one or both of an audio connection and a video over internet protocol (VoIP) connection;
wherein the communications feature provides a channel of communication between the receive station and fixed location call station.

19. The computer readable storage medium of claim 17, wherein the instructions further comprise providing the user input to the receive station.

20. The computer readable storage medium of claim 17, wherein the instructions further comprise:
determining the location of a user of the mobile call station using fixed location call station location information; and
providing the location information as part of the user input to the receive station.
